(19) United States
(12) Patent Application Publication
(10) Pub. No.: US 2018/0326632 A1
(43) Pub. Date: Nov. 15, 2018

(54) Insert for Use in an Injection Molding Nozzle and Injection Molding Nozzle with Such an Insert

(71) Applicant: GÜNTHER Heisskanaltechnik GmbH, Frankenberg (DE)

(72) Inventors: Herbert GÜNTHER, Allendorf (DE); Siegrid SOMMER, Burgwald (DE); Torsten SCHNELL, Lichtenfels (DE)

(21) Appl. No.: 15/976,498

(22) Filed: May 10, 2018

(30) Foreign Application Priority Data
May 11, 2017 (DE) 10 2017 110 298.1

(51) Int. Cl. B29C 45/20

(52) U.S. Cl. CPC B29C 45/20

(57) ABSTRACT

Disclosed is an insert for an injection molding nozzle, with an insert body, in which at least one flow channel is formed with an inlet opening and an outlet opening, wherein the insert body comprises a neck section, for joining to the injection molding nozzle, an end section, for inserting into a mold cavity of a mold insert. Furthermore, the insert body has a flange projecting radially with respect to the end section, having a stopping surface facing the outlet opening and a surface facing the inlet opening. It is proposed that the neck section has at least one seal.

### CROSS-REFERENCE TO RELATED APPLICATIONS

This application claims priority to German Patent Application No. 10 2017 110 298.1 filed May 11, 2017, entitled “Insert for Use in an Injection Molding Nozzle and Injection Molding Nozzle with Such an Insert,” which is incorporated by reference herein in its entirety.

### FIELD OF INVENTION

The invention relates to an insert for use in an injection molding nozzle as well as an injection molding nozzle for an injection mold with an insert.

### BACKGROUND

Injection molding nozzles, especially hot-channel nozzles, are used in injection molds in order to supply a fluid compound, such as a plastic material, at a given temperature under high pressure to a releasable mold insert. They usually have a material tube with a flow channel which is fluidically connected by an inlet opening to a distributor channel in a distributor plate and emerges by an outlet opening in the gate opening of the mold insert (mold cavity).

So that the flowable material within the flow channel of the hot-channel nozzle does not cool down prematurely and harden, a heating device is provided, being placed or arranged on the outside of the material tube. Moreover, in order to ensure that the flowable compound is held at a uniform temperature up to the gate opening, a heat conducting sleeve made of a high thermal conductivity material can be inserted at the end side in the material tube, being a continuation of the flow channel and forming at the end side the outlet opening for the injection molding nozzle.

In the case of an open nozzle, the heat conducting sleeve is usually designed as a nozzle mouthpiece and provided with a nozzle tip, terminating by its conical tip in or shortly before the plane of the gate opening. In the case of a needle valve nozzle, a tight seat for a valve needle is formed at the end side in the outlet opening of the heat conducting sleeve, which can move back and forth by means of a needle drive between an open and a closed position.

When processing abrasive materials or injection molding compounds which contain abrasive components, severe wear may occur on the heat conducting sleeve, especially at the outlet opening, so that the heat conducting sleeve or—depending on the design—the entire hot-channel nozzle needs to be replaced rather often. Especially in the case of needle valve nozzles, damage occurs to the tight seat for the valve needle, so that this can no longer be moved precisely from an open to a closed position during the periodic movement and the outlet opening is no longer tightly closed.

Furthermore, the individual components of an injection molding nozzle are generally exposed to an abrasive and adhesive wear. This wear is due to the fact that metallic components rub against other metallic components, without it being possible to use a lubricant, which might contaminate the injection molded products being produced.

In order to prevent wear, WO 2005/018906 A1 proposes an insert which is preferably made from a wear-resistant material. This is arranged at the mold insert-side end of a nozzle mouthpiece and is designed to be lengthwise movable either in itself or together with the nozzle mouthpiece. The insert serves for protection of the nozzle mouthpiece against heavy wear and optimizes the needle guidance of needle valve nozzles, since it functions as a centering body for both the valve needle and for the nozzle.

One problem here is that the insert must constantly be joined tightly to the nozzle mouthpiece or a heat conducting sleeve. But often this cannot be ensured, so that solvent for example contained in the flowable compound can creep into the inserting area of the insert. Even a slight leaking in this area may decide whether the product can be sold or needs to be picked out as a reject.

Furthermore, such inserts are usually adapted to be lengthwise movable, so that the insert can move between mold insert and nozzle during the operation. This results in different bearing surfaces of the insert against the nozzle mouthpiece or against the heat conducting sleeve and consequently undesirable overhangs at the articles being produced, which furthermore entails different temperatures.

### SUMMARY OF INVENTION

The goal of the invention is to overcome these and other drawbacks of the prior art and to create a compact insert for an injection molding nozzle, which can be inserted with no leakage into a material tube, a nozzle mouthpiece, or a heat conducting sleeve of an injection molding nozzle. The insert should be easy and economical to produce. Furthermore, a positioning of the insert with respect to the injection mold should be easier and more precisely achievable. Furthermore, an optimal heat transfer should be possible from the injection molding nozzle to the insert and the insert should be interchangeable.

In an insert for an injection molding nozzle, with an insert body in which at least one flow channel is formed with an inlet opening and an outlet opening, wherein the insert body comprises a neck section, an end section, and a flange projecting radially with respect to the neck section and the end section, the flange having a stopping surface facing the outlet opening and a surface facing the inlet opening, the neck section comprises a seal.

The seal has the effect that no leakage can occur between the insert and the injection molding nozzle. In this way, injection molded articles can be produced in constantly high quality and rejects can be minimized. The neck section serves for connecting to the injection molding nozzle, i.e., it is inserted for example in a heat conducting sleeve, a nozzle mouthpiece or a material tube of the injection molding nozzle. But it is also possible to design the insert and the neck section such that the insert is shoved by its neck section onto the heat conducting sleeve, the nozzle mouthpiece or the material tube. The seal of the insert is constantly in contact by at least one of its surface sections with the injection molding nozzle or its components.

This is also enabled by the design wherein the seal of the insert is configured as a sealing ring. This can be produced easily and economically and placed on the neck section of the insert. A sealing ring furthermore enables an easy preassembly on the insert. It is preferable that the inner diameter of the sealing ring is adapted to the outer diameter of the neck section of the insert, so that for example a force locking and/or form fitting connection of the sealing ring to the insert can be accomplished. The sealing ring can moreover be preassembled on the insert, without other fastening elements being needed.

If the seal is fashioned as a sealing ring, a contour of the sealing ring may be provided that preferably has a uniform cross section over the overall circumference. In this way, the insert with sealing ring can be easily inserted into the injection molding nozzle, without needing to observe a particular orientation of the two components to one another. Furthermore, such a sealing ring can be produced easily and economically.

One embodiment proposes that the seal forms a positioning ring. In this way, the seal additionally provides a constantly correct and exact positioning of the insert relative to the injection molding nozzle and to the mold insert (mold cavity), namely, to the edge of the article being produced. The preferably lengthwise movable insert is thus situated in the installed state constantly in the same position in the mold and the temperature control of the nozzle only has to be adjusted once. Neither do any additional components need to be used for a correct positioning, for example ensuring a minimum spacing between the flange of the insert and the injection molding nozzle. The handling and the installing of the injection molding nozzle is in this way significantly easier. If the insert at the same time is designed as a valve needle guide and valve needle sealing element, the solution according to the disclosure ensures a constantly precise orienting and guiding of the valve needle.

In a preferred modification it is proposed that the seal has a substantially rectangular cross section. Preferably the long side of the rectangle extends in the longitudinal or axial direction to the neck section. A sealing ring so configured can be produced easily and enables a good sealing action.

Preferably, the substantially rectangular cross section of the seal comprises at least one concave and/or convex formation. In this way, both the sealing function and the positioning function are realized in that the seal when mounting the injection molding nozzle can be deformed to a defined degree and can adapt to the given sealing surfaces of the injection molding nozzle and the insert.

A preferred embodiment proposes that the sealing ring has a partial circular formation on at least one of the long sides. Preferably, two partial circular formations are arranged on opposite long sides of the rectangular cross section surface.

If this at least one formation of the substantially rectangular cross section is formed on the outside, this corresponds to a convex formation. This makes possible an automatic orienting of the sealing ring when bringing together the sealing ring with the insert and the injection molding nozzle. The seal lies at least by this convex formation against the neck section and/or in the installed state against a surface of the injection molding nozzle. The convex formation can furthermore improve the sealing effect, since in the final mounted state of the injection molding nozzle an increased force acts on this region of the seal.

Alternatively, at least one concave formation is preferably provided. In this configuration, at least one of the long surfaces of the rectangular cross section is formed to be partly circular on the inside. In this way, a recess is produced in the sealing ring, which enables a better adapting of the seal when bringing together the insert with an injection molding nozzle.

Preferably, the seal has two convex or two concave formations, the formations being formed on opposite long sides of the seal or the sealing ring. In this way, a very good sealing effect can be achieved.

Another embodiment proposes that the seal comprises at least one cutting and/or pinching edge in the longitudinal direction of the insert. This cutting and/or pinching edge is designed in its wall thickness and length so that it becomes deformed upon mounting the injection molding nozzle and upon heating the mold in the plastic region so that an optimal sealing is achieved and at the same time an exact positioning of the insert relative to the injection molding nozzle is assured, without the material tube, the heat conducting sleeve or the nozzle mouthpiece of the injection molding nozzle suffering damage. The deformed region of the seal, i.e., the cutting and/or pinching edge, is consequently both a seal and a spacer, which exactly positions the insert so that it always lies flush with the surface of the article being molded in the injection region.

It will be noticed that the cutting and/or pinching edge forms an extension of the seal in the longitudinal direction of the insert, having a cross section which tapers as compared to the rectangular cross section of the seal and which extends preferably in the direction of the flange. This extension is preferably formed on the short side of the substantially rectangular cross section and therefore serves for the exact positioning of the seal and thus the insert relative to the injection molding nozzle and thus also to the mold insert. The extension acts as a cutting and/or pinching edge when installing the insert in the injection molding nozzle and is more easily deformed during its mounting than for example the rectangular main cross section of the seal, which accomplishes an increased sealing action.

In one preferred configuration, the seal is arranged on an outer circumference of the neck section. In this way, the seal may be quickly and conveniently mounted on the insert.

It is further favorable to the function of the seal when a circumferential recess for the seal is formed in the outer circumference of the neck section. Hence, it is always held securely in place. Thanks to the circumferential recess, moreover, a correct and precise positioning of the seal is assured. The seal cannot slip. Instead, it is held with form fit in the circumferential recess.

In a further configuration, the seal is arranged adjacent to the radially projecting flange. Moreover, it is preferably in contact with the surface of the flange facing the inlet opening, in which case the extension in the form of the cutting and/or pinching edge is preferably in contact with the surface of the flange.

Thus, the seal is braced by the extension or the cutting and/or pinching edge against the flange, which ensures that the insert is always positioned correctly inside the mold. Furthermore, this also assures a constantly correct positioning of the insert when installing it in the injection molding nozzle, so that an optimal sealing and an optimal temperature control of the flowable compound can be assured during its movement through the flow channel.

The seal preferably lies in the lower region of the neck section, the lower region of the neck section being formed adjacent to the radially projecting flange. Advantageously, the seal is in contact at least for a portion with the surface of the flange facing the inlet opening.

If the neck section is inserted into or onto a heat conducting sleeve, a nozzle mouthpiece or a material tube, this configuration enables on the one hand a precise contact between the two components and on the other hand a reliable sealing effect. The sealing effect of the seal can be utilized in the best possible way both in the radial and in the axial direction.

In one preferred configuration, the seal is deformable. In this way, the best possible sealing effect can be achieved when producing the insert with the seal and when assembling the insert with the injection molding nozzle. An optimal sealing effect is achieved in that forces of deformation act on the seal, so that the seal is pressed against the free space between insert and injection molding nozzle and is thus adapted.

Preferably, the thickness of the seal in the radial direction is designed such as to achieve the best possible deformability.

In one preferred embodiment, the seal comprises a metallic material. Metallic materials can be chosen flexibly according to the desired requirements. Especially preferred is copper for example, since this has a good deformability while at the same time having good heat transmission.

If, for example, a copper seal is used, the seal can on the one hand be deformed when assembling the insert with the injection molding nozzle such that an optimal sealing effect is obtained, and on the other hand copper has good thermal conductivity, so that for example heat can be transferred from the heat conducting sleeve to the insert and thus the flowable compound is optimally temperature-controlled up to the outlet opening.

Alternatively, the seal comprises plastically deformable materials, especially plastics, which are resistant to solvents and heat, or ceramics, with good deformation properties and high thermal conductivity.

In one preferred configuration, the flange has a thread on a radially outer surface. In this way, the insert can be easily mounted in or removed from an injection molding nozzle.

In an advantageous configuration, the insert is rotationally symmetrical to a longitudinal axis. This form of the insert is easy and economical to produce, and it can also easily be mounted in the injection molding nozzle, since no special orientation of the insert needs to be produced.

In a preferred embodiment it is provided that the insert body is two-piece. Preferably the insert body comprises a first part and a second part, wherein the first part is formed substantially by the neck section and the second part substantially by the end section. It is preferably provided that the first part is made from a high thermal conductivity material and extends from the neck section of the insert body as far as a boundary surface and the second part is made from a second material, which is different from the high thermal conductivity material of the first part, wherein the second part extends from the boundary surface as far as the end section of the insert body, and wherein the first part and the second part are joined to each other in and/or along the boundary surface.

In this way, it is possible to combine several material properties in only a single component, which is inserted for example into the lower, mold cavity-side end of a material tube or a heat conducting sleeve of the injection molding nozzle, and to utilize them for the injection molding nozzle and the flowable material to be processed, without requiring and having to install several different components. The different materials can be chosen and combined in accordance with the requirements. If the first part of the insert is made from a high thermal conductivity material, the heat generated by a heating of the injection molding nozzle can be taken as far as possible up to the gate opening.

The second part, on the other hand, made from a second material, can be produced for example from a wear-resistant material, in order to reduce the wear on the insert and thus increase the service life of the injection molding nozzle, especially when the second part of the insert forms the tight seat for a valve needle.

Preferably, the second material has a lesser thermal conductivity than the high thermal conductivity material.

The first part and the second part of the insert can advantageously be made as separate parts, which are precisely and firmly joined together after their fabrication. Alternatively, it is also possible to produce at first a rough blank from a composite of the high thermal conductivity materials and the third material and then fabricate the insert from this composite. Thanks to the connection of the two parts of the insert consisting of two different materials with an additional coating, the advantageous properties of the materials can be chosen precisely and utilized in the best possible way in the smallest structural space. A cost and maintenance intensive installation of different single parts is avoided. Likewise, no costly sealing elements or sealing surfaces are needed between the two parts, which might result in leakage at or in the injection molding nozzle or in the mold. Instead, the two parts are constantly joined together firmly and the insert forms a unitary component in its handling with minimal dimensions.

The connection extends by virtue of the boundary surface between the different materials used, so that although the properties of several materials are combined in a single component, at the same time a clear demarcation of materials is ensured on the different parts. A mixing of the two substances outside the boundary surface is prevented. This contributes to the optimal and precise utilization of the materials when using an insert in an injection molding nozzle.

Embodiments propose that the first part and the second part are joined together by integral bonding, form fitting, or frictional locking. With an integrally bonded connection, minimum dimensions can be achieved. But mechanical connections in the form of a form fitting or a frictional locking are also conceivable, for example by interlocking, screw fastening, press fitting or shrink fitting.

Preferably, the first part and the second part are joined together with integral bonding at the boundary surface, especially welded, soldered, or glued.

Due to the limited structural space, it is especially advantageous when the first and second part are joined together with integral bonding by means of welding, preferably by means of diffusion welding or laser welding.

Welding has proven to be the optimal method for connecting the first and the second part, because the first and the second part are usually formed from a metallic material and welding can produce a reliable and long-lasting stable connection between the parts. Diffusion welding in particular has benefits over other welding methods. The quality of the welded connections is exceptionally high. A pore-free, tight material composite is formed, meeting the highest mechanical, thermal and corrosion requirements. With diffusion welding, it is not necessary to use any added material, so that the seam has no foreign alloy components and thus possesses properties similar to those of the base materials, when properly designed. Furthermore, thanks to no molten fluid phase in the joining process, a highly precise and contour-true welding can be assured.

Alternatively, the first part can be joined to the second part by means of a mechanical connection arrangement. For this purpose, a locking connection, a screw connection, a press fitting or a bayonet connection can be used, among others. The two parts can also be joined together by shrink fit. All of the aforementioned types of connection have the benefit that such a connection of the first part to the second part is firm and tight.

It is especially advantageous when the second material of the second part is a wear-resistant material. In this way, it is possible to reduce the wear on the insert—for example in the region of a needle guide—on account of the repeated sliding of the valve needle along the inner walls of the flow channel during active operation of the injection molding nozzle. At the same time, a high thermal conductivity design of the first part of the insert, which can be arranged for example on a heat conducting sleeve, ensures an optimal temperature distribution in the gate region.

It has proven to be advantageous when the thermally conductive material and the second material have a high thermal expansion. Thanks to the use of a material with high thermal expansion, the insert expands specifically during the heating of the injection mold, so that after reaching the operating temperature of the injection molding nozzle the insert is optimally clamped between material tube and/or heat conducting sleeve on the one hand and mold insert on the other hand and forms a durable tight arrangement.

In another advantageous design, the material of the first part and the material of the second part have an identical or nearly identical coefficient of expansion.

If the coefficients of expansion of the two parts of the insert are different, the difference between the coefficients of thermal expansion of the thermally conductive and the second material takes into account the elastic capacities of the connection between the first and the second part, so that the two parts of the insert are always joined together durably and firmly.

In a special embodiment, the wear-resistant material is a tool steel. This is distinguished by good wear protection properties. Tool steel is more economical than other materials with comparable wear protection properties. In particular, a tool steel with low thermal conductivity may be advantageous, because in this case there is a thermal separation of the plastic melt from the mold insert of the injection mold, which prevents a premature cooldown of the plastic melt in the region of the second section. The additional coating of a material with a low thermal conductivity additionally supports this effect.

Alternatively, a ceramic which is distinguished by high wear resistance and low thermal conductivity could also be used as the wear-resistant material.

A further embodiment proposes that the boundary surface along which the first part is connected to the second part extends perpendicular to or obliquely to the longitudinal axis of the insert body. In particular, it is proposed that the boundary surface along which the first part is connected to the second part extends solely perpendicular to or obliquely to the longitudinal axis of the insert body

This produces, for example, a disk-shaped boundary surface with minimal expansion. Thanks to the perpendicular run of the boundary surface, an optimal connection can be produced between the first and the second part.

Alternatively to this, the boundary surface may also extend obliquely to the longitudinal axis of the insert body, for example when a larger boundary surface is desired. The latter may be conically formed, for example. Thanks to a boundary surface oriented obliquely to the longitudinal axis, an integrally bonded connection can be strengthened in particular, since in this case a larger section is available as boundary surface.

In another special embodiment, the flange is preferably formed by the first part or the second part. In either variant, the flange is formed uniformly from one material and exhibits the properties of the respective material. In this way, the flange may either continue the heat conducting function of the neck section, for example, or enlarge the region of the end section which is protected by the wear-resistant material.

According to another embodiment, the flange is formed by the first part and the second part. In this way, the properties of the two materials can be combined optimally in the narrowest space. Since the flange functions primarily as a supporting flange, it comprises both regions having contact with the mold insert and regions which may lie against the material tube, the nozzle mouthpiece and/or the heat conducting sleeve, as required. Different requirements must be fulfilled in the two regions of the flange. While the temperature in the transitional region between flange and first section is constantly maintained high, at the same time the heat transfer from the material tube, the nozzle mouthpiece or the heat conducting sleeve to the mold insert is minimal. Furthermore, a more intense wearing must be assumed precisely at the contact surfaces, so that in these places a stronger wear protection is assured. Since the two parts of the different materials form the flange, these opposite requirements can be fulfilled in a single component in the smallest space. This also holds in particular for the overall insert.

According to another advantageous embodiment, the insert forms a centering body for a valve needle of an injection molding nozzle. In this case, the insert forms in the first part and/or in the neck section a flow channel wall which tapers conically in the direction of the flange. Such a wall centers the valve needle during the closing movement, so that the free end of the valve needle can always run precisely in its tight seat. Preferably, the trend of the flow channel in the region of the first part and/or neck section is such that the valve needle is oriented already to the gate opening of the insert. Thus, excessive wear on the valve needle is additionally avoided.

According to another important embodiment, the second part forms a tight seat for a valve needle of an injection molding nozzle. This can be accomplished, for example, by adapting the diameter of the flow channel in the region of the end section to the circumference of the valve needle of a needle valve nozzle. Corresponding embodiments have the advantage that the wear on the insert in the region of the end section, caused by repeated sliding of the valve needle along the surfaces of the flow channel, is significantly reduced.

According to another embodiment, the second part of the insert is configured to form, with its front end, a section of a wall of a mold cavity.

Furthermore, the disclosure relates to an injection molding nozzle for an injection mold with an insert according to the disclosure. The injection molding nozzle may be either a hot-channel nozzle or a cold-channel nozzle. The insert may find use both in injection molding nozzles with open gate and nozzle tips and in injection molding nozzles with heat conducting sleeve and needle valve closure.

Injection molding nozzles with the insert according to the disclosure will benefit from the seal, which is arranged at the neck section of the insert, so that an improved sealing effect can be achieved. Basically, the insert protects the injection molding nozzle against wearing processes and ensures a long-lasting, low-maintenance use of the injection molding nozzle.

Furthermore, the insert can be produced in a simple and economical manner. The positioning of the insert in the injection mold can also be done more precisely.

When the injection molding nozzle is a needle valve nozzle, this has the further advantage that the insert additionally functions as a centering body, because the needle is guided precisely and with stable position inside the insert. Thanks to the improved positioning, the needle guidance can also be further improved. This avoids damage to the valve needle, but also reduces wear processes on the injection molding nozzle.

The injection molding nozzle itself may comprise different components in different embodiments. All embodiments of the injection molding nozzle comprise a material tube, in which at least one flow channel is formed, which is fluidically connected to a mold cavity of the injection mold formed by at least one mold insert.

Depending on the embodiment, the injection molding nozzle furthermore has a heat conducting sleeve, which can be designed as a nozzle mouthpiece. The heat conducting sleeve is inserted into the material tube at the end, or mounted on the material tube, and it forms the outlet opening for the flow channel. The heat conducting sleeve is made from a high thermal conductivity material so that the melt can be fed at constant high temperature to the mold insert, without forming a so-called cold plug.

The insert according to the disclosure is preferably arranged at the mold insert-side end of the material tube, wherein the seal is arranged between the insert and the mold insert side-end of the material tube. In one preferred modification it is proposed that the injection molding nozzle comprises a heat conducting sleeve at whose mold insert-side end is situated the insert with the seal, the seal being arranged between the insert and the mold insert-side end of the heat conducting sleeve. The insert may be inserted into or placed on the material tube or the heat conducting sleeve. The neck section of the insert is adapted thereto accordingly. Furthermore, the seal is preferably adapted to the neck section of the insert and the mold insert-side end of the material tube or the heat conducting sleeve. The insert is furthermore formed separate from the other components of the injection molding nozzle and constitutes a separate component of the injection molding nozzle.

It has proven to be especially advantageous when the insert during the operation of the injection molding nozzle is firmly installed in the material tube, the nozzle mouthpiece or the heat conducting sleeve, yet has an interchangeable design. That is, the insert is clamped or otherwise secured between the material tube and the mold insert, the nozzle mouthpiece and the mold insert, or between the heat conducting sleeve and the mold insert at least as soon as the mold has reached its operating temperature. The insert occupies a predefined position thanks to the seal, in which an optimal heat transfer is made possible from the injection molding nozzle to the insert. In this way, an optimal temperature control of the flowable compound as far as the mold insert can be assured.

Furthermore, it is possible to install and remove the insert quickly and conveniently. No tools or other aids are required for this. Neither do any additional parts or aids need to be provided for the securing of the insert in the injection molding nozzle, such as screw threads, threaded sleeves or the like on the insert itself or in the injection molding nozzle, because the insert is reliably secured during the operation of the injection molding nozzle. Even so, the insert can always be replaced quickly and economically.

Furthermore, it is advantageous when the neck section with the seal is form fitted at least for a portion to the material tube, the nozzle mouthpiece or the heat conducting sleeve and/or the end section is form fitted at least for a portion to the mold insert. Thanks to the form fitting, a tight connection is achieved, thereby preventing the melt from getting into interstices. Thus, the insert with the other parts of the injection molding nozzle forms a plug-in system, from which the insert can be easily removed by pulling out without the use of tools, yet at the same time the injection molding nozzle is reliably secured by for example clamping during its operation.

In one preferred embodiment, the insert is arranged at the mold insert-side end of the material tube, the nozzle mouthpiece or the heat conducting sleeve, the mold insert-side end of the material tube, the nozzle mouthpiece or the heat conducting sleeve having a recess, with which the seal of the insert engages. This recess is preferably situated near the mold insert-side end or at the mold insert-side end of the material tube, the nozzle mouthpiece or the heat conducting sleeve. In this way, the insert with the seal can be shoved into or placed on the corresponding component of the injection molding sleeve. The seal is arranged between the neck section of the insert and the recess of the material tube, the nozzle mouthpiece or the heat conducting sleeve and is deformed according to the force acting on it, ensuring the best possible sealing between the insert and the injection molding nozzle.

Furthermore, such an arrangement is simple and economical to produce and install. The seal produces the most precise possible positioning of the components, so that a good temperature control of the flowable compound is made possible up to the mold insert.

### BRIEF DESCRIPTION OF THE DRAWINGS

Further features, details and benefits of the invention will emerge from the wording of the claims as well as the following description of sample embodiments with the aid of the drawings. There are shown:

FIG. 1 is a schematic longitudinal section through a first embodiment of an insert according to the disclosure,

FIG. 2 is a schematic longitudinal section through another embodiment of an insert according to the disclosure,

FIG. 3 is a schematic longitudinal section through another embodiment of an insert according to the disclosure,

FIG. 4 is a schematic longitudinal section through yet another embodiment of an insert according to the disclosure.

### DETAILED DESCRIPTION

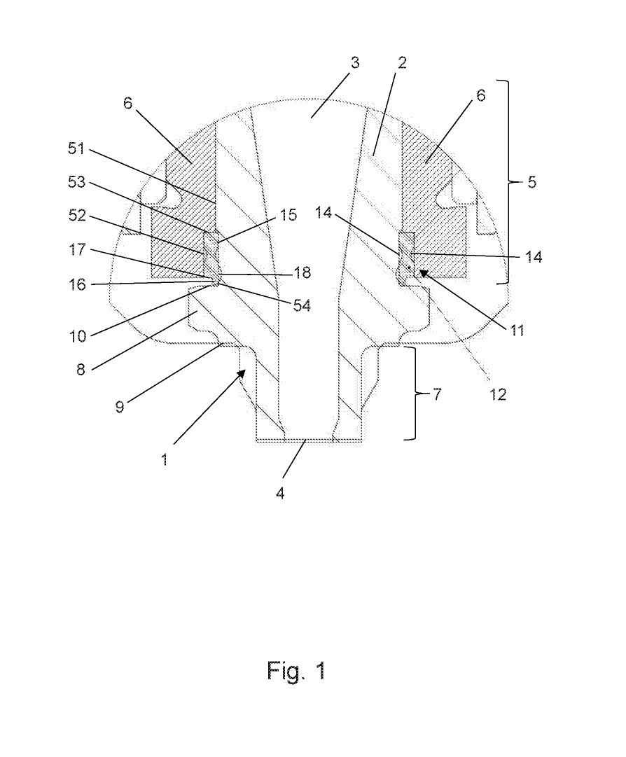

The insert designated generally as 1 in FIG. 1 is intended for use in an injection molding nozzle of an injection mold (not otherwise represented). The injection molding nozzle has a material tube and a heating device, while a heat conducting sleeve 6 is installed in the end of the material tube which is facing a mold insert of the injection mold. The latter accommodates the insert 1 in lengthwise movable manner in the cold state of the injection mold.

The insert 1 has an insert body 2, in which a flow channel 3 is formed with an inlet opening (not visible) and an outlet opening 4. The inlet opening stands in fluidic communication with a melt channel formed in the material tube and the heat conducting sleeve. The outlet opening 4 emerges—if the injection molding nozzle is mounted in the injection mold—directly in a gate opening in the mold insert of the injection mold (also not shown).

The insert 1 moreover has a neck section 5, for introducing or inserting the insert body 2 into the injection molding nozzle, namely into the heat conducting sleeve 6, while the neck section 5 is preferably inserted or press fitted into the heat conducting sleeve 6. At its end opposite the neck section 5, the insert 1 has an end section 7. By this end section, the insert 1 is inserted into the mold insert of the injection mold.

Between the neck section 5 and the end section 7 is formed a flange 8 projecting radially with respect to the neck section 5 and the end section 7. This has a stopping surface 9, which faces the outlet opening 4, and a surface 10, which faces the inlet opening. By the stopping surface 9 the insert 1 can be braced against or on the mold insert, when the injection molding nozzle and the injection mold are mounted. The surface 10 on the flange 8 serves as a supporting surface or abutment for a seal 11, which is formed on the neck section 5 of the insert.

It can be seen in FIG. 1 that the seal 11 is arranged preferably in the lower region of the neck section 5, the lower region of the neck section 5 being formed adjacent to the radially projecting flange 8. The seal 11 sits like a closed ring on the outer circumference 51 of the neck section 5. The latter is provided with an encircling circumferential recess 52 in this region, so that the seal 11 lies in the circumferential recess 52. The latter is bounded by a step 53 in the longitudinal direction L of the insert body 2 at its end 53 facing the inlet opening of the flow channel 3, while the end of the circumferential recess 52 facing the outlet opening 4 is bounded by the flange 8 and its surface 10.

The seal 11 has a main body 12 with a substantially rectangular cross section as well as an extension 16, which is tapered relative to the rectangular cross section and by which the seal 11 is braced against the flange 8. The extension is therefore situated on the short side 17 of the rectangular cross section of the seal. In each of the long sides 15 of the rectangular cross section of the seal 11 there is produced a concave formation 14. These may be formed lying opposite each other. The formations 14 may also lie at different heights in the longitudinal direction L.

The seal 11, preferably made from a deformable material, such as a metal, thus forms at first a sealing ring for the insert 1, which seals off the insert body 2 against the heat conducting sleeve 6 when the insert 1 is inserted into the heat conducting sleeve 6 and the injection molding nozzle is mounted in the injection mold. As soon as the latter has reached its operating temperature, the main body 12 of the seal 11 and the extension 16 are deformed to such an extent that a durable reliable seal is created between the insert 1 and the heat conducting sleeve.

The extension 16 forms in this case a cutting and/or pinching edge, which is designed such in its dimensions that it is deformed by the flange edge in the plastic region. At the same time, the concave formations 14 ensure that the main body 12 of the seal 11 can also be deformed specifically between the neck section 5 of the insert body 2 and the heat conducting sleeve 6, so that a durable reliable seal is created between the insert 1 and the heat conducting sleeve 6. The heat conducting sleeve 6 is not damaged in this process, since the extension 16 cuts only into the flange 8 of the insert body 1.

The sealing ring thus creates a durable reliable seal in the insulation region of the injection molding nozzle, i.e., the plastic being processed or its components can no longer get through between the insert 1 and the heat conducting sleeve 6 to the outside and into the forechamber region—filled or unfilled depending on the area of application—of the injection molding nozzle. The insert 1 thus not only protects against wear during the processing of abrasive media, but also ensures a durable reliable sealing.

Yet the seal forms not only a sealing ring, but also a positioning ring.

Once the injection mold has reached its operating temperature, the seal 11 forms with its main body 12 and the extension 16 a defined end stop between the flange 8 and the heat conducting sleeve 6. The seal 11 in this process is braced by the extension 16 inside the circumferential recess 52 against the surface 10 of the flange 8. The insert 1 thus can no longer be moved inadvertently in the direction of the material tube. Instead, it forms a defined end stop for the injection molding nozzle relative to the mold insert of the injection mold, wherein the insert 1 is positioned always flush with the surface of the article being molded. This effectively prevents unwanted overhangs at the boundary surface of the article.

The seal 11 thus ensures an always exact positioning of the insert 1 and thus the injection molding nozzle in the mold.

It may be provided that the insert 1 in the region of the extension 16 has an indentation 18 adapted to the extension 16, into which the extension 16 can be pressed when installed in an injection molding nozzle 6. In this way, the sealing effect can be further enhanced, as can the precision of the positioning.

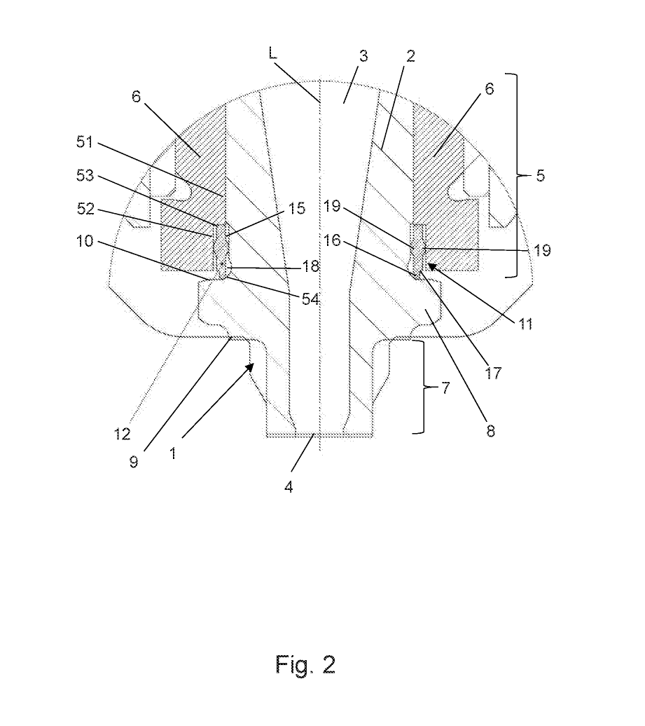

FIG. 2 shows another embodiment of an insert 1 with a seal 11 on the neck section 5.

The seal 11 also here has a main body 12 with a substantially rectangular cross section as well as an extension 16, which is tapered relative to the rectangular cross section and by which the seal 11 is braced against the flange 8. The extension is situated on the short side 17 of the rectangular cross section of the seal.

By contrast with the embodiment of FIG. 1, however, no concave formations 14 are made in the long sides 15 of the rectangular cross section of the seal 11. Convex formations 19 are provided on the long sides 15. These may be formed opposite each other. The elevations 19 may also lie at different heights in the longitudinal direction L.

The seal 11, preferably made from a deformable material, such as a metal, thus forms a sealing ring for the insert 1, which seals the insert body 2 against the heat conducting sleeve 6 when the insert 1 is installed in the heat conducting sleeve 6 and the injection molding nozzle is mounted in the injection mold. Once this has reached its operating temperature, the main body 12 of the seal 11 with the formations 19 and the extension 16 are deformed to such an extent that a durable reliable sealing is produced between the insert 1 and the heat conducting sleeve.

The extension 16 forms in this case a cutting and/or pinching edge, which is designed such in its dimensions that it is deformed by the flange edge in the plastic region. The latter also holds for the formations 19, which are pressed with an increased force against the neck section 5 and the heat conducting sleeve 6.

At the same time, the sealing ring 11 here also forms a positioning ring, which holds the insert 1 in a defined position with respect to the heat conducting body 6.

FIG. 1 and FIG. 2 both show embodiments in which the insert 1 is installed in an injection molding nozzle, with the insert 1 sitting in a heat conducting sleeve 6. But the insert may also be inserted directly into the material tube or into a nozzle mouthpiece of the injection molding nozzle—depending on the application and the design of the injection molding nozzle. In this case, the neck section 5 preferably sits with slight movement play in the injection molding nozzle.

Alternatively, it is also possible to configure the insert 1, especially the neck section, so that it is placed on an outer circumference of the heat conducting sleeve 6. The same holds for the mounting of the insert 1 directly on the material tube or on a nozzle mouthpiece.

For the receiving of the seal 11 in the heat conducting sleeve 6 there is provided a recess 22, whose inner wall (not otherwise indicated) forms a sealing surface.

This recess 22 is preferably adapted to the seal 11 or the sealing ring 12. Thus, the recess 22 may be formed as an encircling ring with a substantially rectangular cross section.

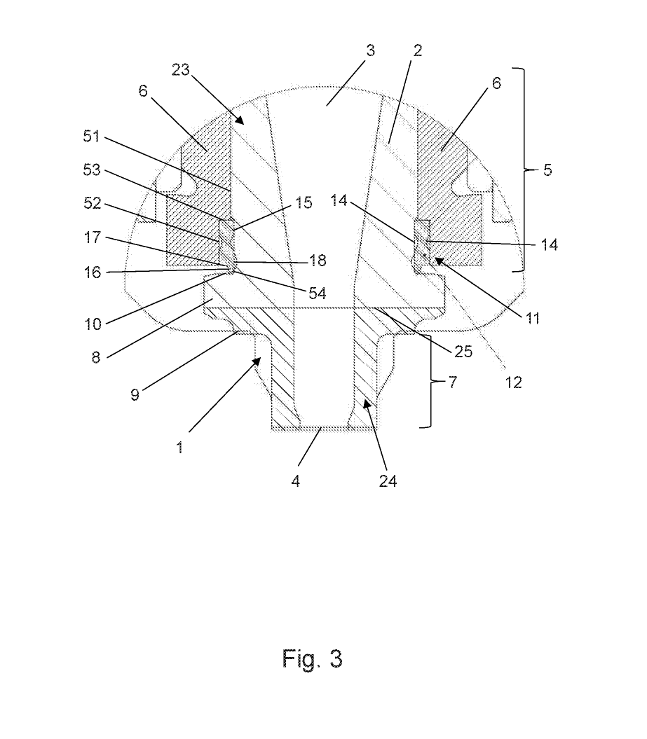

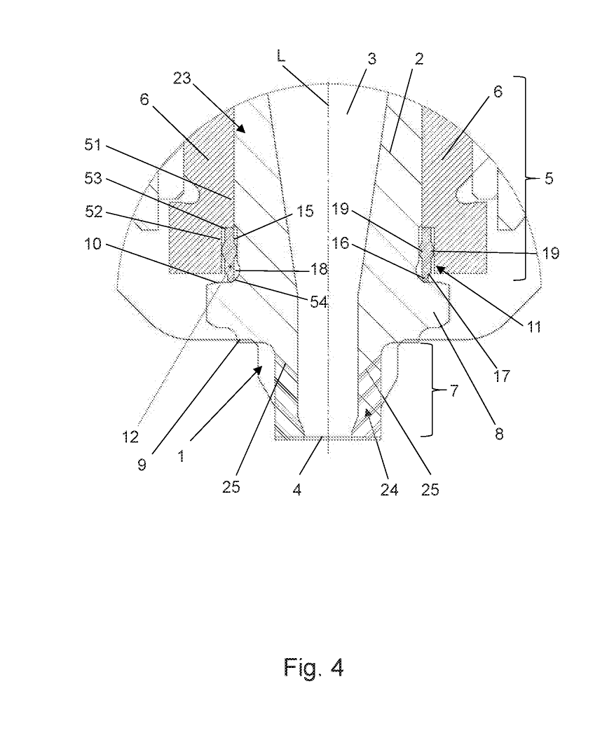

FIGS. 3 and 4 each show a longitudinal section through another preferred embodiment of an insert 1. In both FIGS. 3 and 4, the insert body 2 is two-piece. The insert body 2 comprises a first part 23 and a second part 24. The first part 23 is formed substantially by the neck section 5 and the second part 24 is formed substantially by the end section 7. It is preferable for the first part 23 to be made from a high thermal conductivity material and to extend across the neck section 5 of the insert body 2 as far as a boundary surface 25. The second part 24 is made from a second material and extends from the boundary surface 25 across the end section 7 of the insert body 2. The two parts 23, 24 are joined together in and/or along the boundary surface 25.

FIG. 3 shows that the boundary surface 25 extends between the first part 23 and the second part 24 perpendicular to the longitudinal axis L of the insert body 2.

FIG. 4 shows an alternative configuration of the boundary surface 25. Here, the boundary surface 25 extends between the first part 23 and the second part 24 obliquely to the longitudinal axis L of the insert body 2.

All features and advantages emerging from the claims, the specification, and the drawing, including design details, spatial arrangements, and method steps, may be significant to the invention both in themselves and in the most varied of combinations.

### LIST OF REFERENCE NUMBERS

1 Insert
2 Insert body
3 Flow channel
4 Outlet opening
5 Neck section
51 Outer circumference
52 Circumferential recess
53 End
54 End
6 Heat conducting sleeve
7 End section
8 Flange
9 Stopping surface
10 Surface
11 Seal
12 Sealing ring
13 Depression
14 Concave formation
15 Long sides of seal 11
16 Extension/cutting/pinching edge
17 Short side of seal 11
18 Indentation
19 Convex formation
22 Recess
23 First part
24 Second part
25 Boundary surface
L Longitudinal axis of insert 1

What is claimed is:

1. An insert for an injection molding nozzle, with an insert body in which at least one flow channel is formed with an inlet opening and an outlet opening, wherein the insert body comprises a neck section, an end section, and a flange projecting radially with respect to the neck section and the end section, the flange having a stopping surface facing the outlet opening and a surface facing the inlet opening, wherein the neck section comprises a seal.

2. The insert as claimed in claim 1, wherein the seal is configured as a sealing ring.

3. The insert as claimed in claim 1, wherein the seal forms a positioning ring.

4. The insert as claimed in claim 1, wherein the seal has a substantially rectangular cross section.

5. The insert as claimed in claim 4, wherein the substantially rectangular cross section of the seal comprises at least one concave and/or convex formation.

6. The insert as claimed in claim 1, wherein the seal comprises at least one cutting and/or pinching edge in a longitudinal direction of the insert.

7. The insert as claimed in claim 1, wherein the seal is arranged on an outer circumference of the neck section.

8. The insert as claimed in claim 7, wherein a circumferential recess for the seal is formed in the outer circumference of the neck section.

9. The insert as claimed in claim 1, wherein the seal is arranged adjacent to the radially projecting flange.

10. The insert as claimed in claim 1, wherein the seal is in contact at least for a portion with the surface of the flange facing the inlet opening.

11. The insert as claimed in claim 10, wherein the seal stands in contact with the surface of the flange by a cutting and/or pinching edge.

12. The insert as claimed in claim 1, wherein the insert body is two-piece, the first part being formed substantially by the neck section and the second part being formed substantially by the end section, and wherein the first part is made from a high thermal conductivity material and is configured to extend from the neck section of the insert body as far as a boundary surface and the second part is made from a second material, which is different from the high thermal conductivity material, wherein the second part is configured to extend from the boundary surface as far as the end section of the insert body, and wherein the first part and the second part are joined to each other in and/or along the boundary surface.

13. The insert as claimed in claim 12, wherein the boundary surface extends perpendicular or obliquely to a longitudinal axis of the insert body.

14. The insert as claimed in claim 11, wherein the first part and the second part are welded together in and/or along the boundary surface.

15. An injection molding nozzle for an injection mold with an insert as claimed in claim 1.
